(19) United States
(12) Patent Application Publication
(10) Pub. No.: US 2002/0053757 A1
(43) Pub. Date: May 9, 2002

(54) Methods and systems for removing flashing and other irregularities from molded starch-bound articles

(76) Inventors: Per Just Andersen, Santa Barbara, CA (US); Simon K. Hodson, Santa Barbara, CA (US)

Correspondence Address: JOHN M. GUYNN, WORKMAN, NYDEGGER & SEELEY, 1000 Eagle GateTower, 60 East South Temple, Salt Lake City, UT, 84111, US

(21) Appl. No.: 09/758,477

(22) Filed: Jan. 11, 2001

(51) Int. Cl. B26D 7/06

(52) U.S. Cl. 264/428; 83/426

(57) ABSTRACT

Apparatus and systems for finishing molded articles, such as fragile starch-bound articles, having flashing or other extraneous mold material attached thereto. The containers are conveyed from the mold apparatus to the flash removal system, which preferably includes a first flashing removal subsystem that involves cutting and a second flashing removal subsystem that involves abrading. The first removal subsystem cuts or slices off all, or substantially all, of the flashing without damaging the molded article. The second removal subsystem sands or abrades any remaining nubs or protrusions not removed by the rough removal subsystem. The removed flashing is preferably recycled to a mold material feed stream in order to provide material inputs for producing new molded articles.

### RELATED APPLICATION.

This application is a continuation of copending U.S. application Ser. No. 09/356,719, filed Jul. 20, 1999.

### BACKGROUND OF THE INVENTION

1. The Field of the Invention.

The present invention relates to apparatus and systems for finishing foamed starch-bound articles. More particularly, the present invention relates to apparatus and systems for finishing foamed starch-bound containers and other articles. Such systems involve the removal of “flashing” and other irregularities found in newly molded starch-bound containers and other articles, as well as the optional recycling of such irregularities.

2. The Relevant Technology

Articles having a starch-bound matrix, whether foamed or nonfoamed, are gaining increasing attention in the marketplace as a useful alternative to substantially non-renewable or long-term renewable resources such as polystyrene or paper. Such starch-based materials can be typically formed by molding, extruding, rolling, and other well-known shaping processes. Die press molding is a particularly useful method for manufacturing 3-dimensional articles from starch-based materials.

Die press molding generally involves placing an appropriate composition between a pair of molds, usually paired male and female molds, and then closing the molds in order form a die cavity within the mold pair corresponding to the shape of the desired molded article of manufacture. In the case of aqueous starch-based compositions, it will usually be necessary to provide vent holes or some other vent means for releasing pent up water vapor that forms as a result of heating the aqueous starch-based compositions. The formation of internal water vapor is beneficial in that it causes the mold material to expand, foam and fill the mold cavity. Further heating causes the expanded mold material to become dry and substantially solidified.

In general, it will typically be necessary to employ an excess of mold material in order to ensure complete formation of the molded article. Under-filling of the molds may result in discontinuities or other defects within the molded articles. Inadequate pressure buildup due to under-filling may also result in the collapse of the cellular structural matrix before being solidified into the desired 3-dimensional shape. Depending on the location of the vent holes, the uniformity or lack thereof of heat applied by the molds, as well as the rate of expansion and the flow properties of the mold material, different sections of the mold cavity may preferentially fill before other sections, thus necessitating an initial excess of mold material within the mold cavity.

Whereas the use of excess mold material increases the likelihood that the molded articles will be properly formed, such an excess of mold material will either have to be expelled from the molds through the vent holes or other venting means or else heavier, more dense articles will result. In order to yield articles having substantially uniform weight and density it will usually be desirable for the excess mold material to be allowed to escape from the molds through vent holes or other venting means.

Upon being expelled from the molds, the excess mold material typically hardens and remains attached to the molded articles, thereby forming unwanted irregularities which are sometimes referred to in the art as “flashing”. Flashing can be quite conspicuous and substantial and will generally need to be removed in order to prevent clogging of the downstream handling equipment and in order to yield an aesthetically pleasing article. The flashing must usually be removed before further processing can take place, which is just after demolding. However, newly molded articles are usually in their most fragile and brittle condition in the moments just after demolding, since strength and flexibility are usually imparted to the starch-bound cellular matrix by means of subsequent coating and/or absorption of moisture after demolding of the newly molded starch-bound articles. Hence, it has heretofore not been possible to remove flashing from newly molded starch-bound containers and other articles without causing considerable damage to the articles, such as fracture or cracking of the article walls, or pitting and divoting of the outer edge of the articles where the flashing is attached.

One method used to remove flashing involves the use of a scraper bar to mechanically break off and remove the flashing from the molded articles while still in the female mold halves. The scraper bar generally works by being dragged across the tops of the female mold halves after separation of the male and female mold halves and just prior to removing the articles from the female mold halves in order break off and remove the flashing. A major downside of using a scraper bar, which lacks any transverse cutting movement, is that it works by crudely breaking off the attachments that connect the flashing to the article wall, which can leave divots, protrusions, cracks and other irregularities. Another problem is that more strongly attached flashing can actually resist breakage at the desired point, which may result in severe fracture of the article sidewall, thus resulting in a damaged article unfit for use that must be removed from further processing and discarded.

Because of the extreme fragility, brittleness and weakness of newly demolded starch-bound articles, particularly starch-bound having a foamed cellular matrix, the scraper bar can only be used to break off the flashing while the article remains in the mold. If the scraper bar were used to break off and remove the flashing from newly demolded starch-bound articles while in an extremely fragile, weak and brittle condition, a large percentage (perhaps most if not all) of the articles would likely be damaged as a result. This is particularly true for newly molded starch-bound articles having a foamed cellular matrix.

One major downside to the removal of flashing from articles while they remain in the molds is that the pieces of flashing can spill out and clog the molds and surrounding apparatus, depending on how the molds are designed and arranged. Another is that of time and delay. Rather than freeing up the molds for the next molding cycle, removal systems such as those which employ the use of a scraper bar that require the newly molded articles to remain in the molds, tie up the molds and prevent the start of the new molding cycle until after the flashing removal process has been completed and the articles can be demolded.

In short, there has been a long-felt need for improved flashing removal systems that would allow for the flashing to be more cleanly removed, with fewer damaged articles, preferably outside the mold so as to free up the mold for additional molding cycles. The use of the scraper bar flashing removal technique discussed herein has not adequately addressed or satisfied this long-felt need.

In view of the foregoing, it would satisfy a long-felt need to provide apparatus and systems for removing flashing and other irregularities from molded starch-bound articles which did not result in the substantial formation of divots or other depressions which could be mechanically and/or aesthetically undesirable.

In addition, it would be an advancement in the art to provide apparatus and systems for removing flashing and other irregularities from molded starch-bound articles which did not leave substantial quantities of burrs or other raised portions which could be mechanically and/or aesthetically undesirable.

It would be a further advancement in the art to provide apparatus and systems for removing flashing and other irregularities from molded starch-bound articles which did not cause substantial fracture, cracking, breakage or other types of mechanical failure of the molded articles upon removing the flashing or other irregularities.

It would yet be an advancement in the art if such apparatus and systems for removing flashing and other irregularities from molded starch-bound articles provided for the recycling of such materials back into the molding compositions used to manufacture additional articles of manufacture.

It would be a vast improvement in the art to provide apparatus and systems that provided for the removal of flashing from articles after they have been removed from the molds, thereby keeping the flashing from clogging the molds or otherwise interfering with the mold apparatus, and also more quickly freeing up the molds so that they may immediately be used in a subsequent molding cycle.

Such apparatus and systems for more efficaciously removing flashing and other irregularities from newly molded articles of manufacture, particularly articles having a starch-bound cellular matrix, are disclosed and claimed herein.

### SUMMARY AND OBJECTS OF THE INVENTION

The present invention relates to apparatus and systems for removing irregularities from molded starch-bound containers and other articles. Such apparatus and systems are designed to remove virtually all such irregularities while substantially preventing or eliminating divots or other depressions and burrs or other raised irregularities in the finished articles. Such apparatus and systems also result in far less fracture and breakage of the molded articles compared to previous methods for removing flashing, such as scraper bars. The result is a higher percentage of finished articles having virtually no irregularities while keeping inadvertent damage to a minimum. In addition, the flash removal systems can be used to removed flashing from newly demolded articles that have been removed from the molds, thus more quickly freeing up the molds for subsequent molding cycles and preventing clogging or interference of the mold apparatus with removed flashing pieces.

The processes for molding foamed starch-bound articles from aqueous starch-based compositions typically yield flashing having one or more globular structures which remain attached to an upper edge of the molded articles, or article walls, by one or more narrow stems or strands. The attachment strands typically have a diameter that is similar, or at least proportional, to the diameter of mold vent holes used to vent water vapor and excess mold material from the heated molds. The mold vent holes have a diameter typically in the order of 0.040-0.060″. Thus, the attachment strands will typically be quite narrow and, thus, fragile, which makes them easy to snap off by bending, which is the concept typically employed by scraper bars. However, such strands or stems will typically break off at their weakest point, which is not always where the strands emerge from the article wall, thus resulting in some residual portion of the strand. In the case of particularly well-formed strands of atypically high strength, the strands my not break off from above the upper edge of the article wall using a scraper bar, but may detach deeper down within the article wall, thereby resulting in the formation of an unwanted divot or cavity in the upper wall edge.

On the other hand, the globular structures may vary greatly in size and but will generally have a total combined size that is proportional to the amount of overfill in the mold apparatus. Sometimes the globular structures will form discrete balls at the ends of the attachment stems or strands. Other times the globules may themselves merge together to form interconnected globular structures of substantially greater size attached to the molded article by a plurality of attachment strands. In most cases, the globular structures will comprise the vast majority of the flashing mass while the attachment strands will only comprise a minor portion. In either case, scraper bars are inadequate for repeated and reproducible removal of flashing without damage a substantial number of articles and/or without leaving a portion of the flashing attached to the articles, which would require manual removal of the remaining flashing to yield a completely smooth outer wall edge.

In view of the tendency for the majority of the flashing mass to comprise relatively large globules attached to the molded articles by one or more narrow diameter strands, a preferred system for removing flashing involves a two-stage removal process: (1) a first rough flashing removal step involving a cutting apparatus for cutting and removing the globules and a substantial portion of the attachment strands and (2) a second fine flashing removal step involving an abrading apparatus for carefully abrading and removing the remaining portions of the attachment strands. Nevertheless, it is within the scope of the invention to employ only one of the foregoing removal steps and apparatus or to employ other finishing processes in addition to one or both of the foregoing steps and apparatus.

In a preferred embodiment, the rough flashing removal step is preferably carried out by a mechanical cutting process that results in cutting, rather than mere breakage, of the attachment stems, as typically occurs using prior art scraper bars. A preferred cutting apparatus for carrying out the first step is configured so as to have a cutting motion transverse to the attachment strands in order for the cutting process to actually cut or slice, rather than bend or break, the flashing. Preferably, the cutter will comprise a saw blade or sharp knife blade that is oriented substantially perpendicular to the attachment strand axes and which moves in a transverse direction in order to slice off the strand at the point where the strand meets the blade or knife edge. The blade or knife may move from side-to-side, around in a circular motion, or in any other appropriate manner in order to facilitate cutting or slicing of the attachment strands. The blade or knife is preferably located a safe distance from the outer edge of the article wall so as to avoid unwanted cutting or other damage to the article wall itself. In many cases, such as in the case of a clam-shell sandwich container, cup, plate, bowl, and other containers, the upper edge of the container will be planar or substantially planar, thus permitting the use of a substantially straight blade or knife. The foregoing apparatus comprise a preferred rough finishing subsystem.

After the rough finishing station cuts off the attachment strands at a desired location or height above the outer edge of the article wall or edge, a residual nub or “whisker” attached to the article is often left behind depending on the margin of safety represented by the distance between the cutting blade and article wall. The residual nub height represents a margin of safety which prevents the rough finishing blade or knife from cutting or otherwise damaging the molded article itself. Due to possible variations in the conveyor equipment, as well as possible variations in the dimensions of the molded articles themselves, the actual height of the nubs may vary. The optimum average nub height will be selected in order to ensure substantially complete removal of the flashing globules while preventing damage to the article wall. Such fine tuning of the residual “nub height” is impossible using the crude scraper bar described herein.

The fine flashing removal step is preferably carried out by a sanding or abrading process that is able to remove the remaining nubs or residual attachment strands while minimizing damage to the article proper. This is preferably carried out by means of a substantially planar sanding sheet or block that is oriented substantially parallel and coplanar to a plane defined by the upper edge of the molded article wall to which the flashing is initially attached. By rapid side-to-side or unidirectional motion, the sanding sheet or other abrading surface is able to sand or abrade away the residual attachment strand nubs down to the surface of the article wall without significantly damaging the article wall. Of course, some minor abrading of the article wall may actually polish and improve the surface of the article wall in some cases and can be tolerated or even preferred so long as the articles are not significantly damaged. In a most preferred embodiment, the sanding process is carried out by a belt sander that travels around in a loop to provide precision sanding in a desired plane. The foregoing apparatus comprise a preferred fine finishing subsystem.

In a most preferred embodiment, it is preferable to urge or bias the articles towards the sanding sheet or other abrasion means in order for the sanding sheet or other abrasion means to exert a desired amount of friction and abrasive action against the articles. This may be accomplished, for example, by means of flexible bristles attached to a plenum surface, which is able to intermittently raise or lower as needed to bias a group of articles against the sanding sheet. In many embodiments, the conveyor will intermittently move and then stop in order to provide a desired residence time during which the sanding sheet and articles are engaged and abrading of the residual nubs occurs. Raising up of the plenum surface and the associated bristles for a desired period of time and at a desired force results in a desired abrading force for a desired period of time in order to remove a desired amount of material from the article wall surface. Thereafter, the plenum is lowered and the conveyor is activated to carry the finished articles away and to provide a new batch of rough finished articles to undergo sanding.

In order to complete the apparatus necessary to provide for continuous removal of flashing of newly molded articles, a conveyor will preferably be employed to continuously transport newly molded articles from the molding apparatus to the rough finishing station and from the rough finishing station to the fine finishing station. In a preferred embodiment, the conveyor will include regularly spaced apart cavities or depressions corresponding to the size and shape of the molded articles. In this way, the conveyor provides “nests” or depressions for reliably maintaining the articles in a desired location along the conveyor, particularly as they are moved into and through the flash removal system. Such nests prevent damage to the fragile and extremely brittle articles by the flash removal apparatus, including the rough finishing system and/or the fine finishing system. As the articles are treated by the flashing-removal apparatus discussed above, the nests or depressions keep the articles in place relative to the cutting and/or abrading apparatus so as to ensure proper cutting and sanding without damage to, and unwanted movement by, the treated articles.

In a preferred embodiment, it will be desirable to recycle the flashing removed by the rough and fine finishing subsystems. The removed flashing fragments and dust may be evacuated from the flashing removal system by means of a suction hood or other vacuum system. The flashing fragments and dust can be recycled back into the mixer and reformed into new articles as desired. In addition, a quality control apparatus can be used to cull out and remove broken or poorly formed articles or articles of otherwise substandard quality. These culls can also be recycled together with the removed flashing.

Although the foregoing flashing removal system maybe employed for a wide variety of compositions and molding systems, it is particularly well suited when used in conjunction with die mold processes involving starch-based compositions. In general, such compositions will initially include water, ungelatinized starch granules, inorganic fillers, fibers, and a gelatinized starch portion that is included to increase the viscosity and yield stress of the fluid fraction in order to ensure good fiber dispersion. Because the molding process generally results in the substantial gelatinization of the initially ungelatinized starch portion of the starting mixture, flashing fragments and damaged containers provide an excellent source of pregelatinized starch as well as fibers and inorganic filler. Because pregelatinized starch is generally far more expensive than ungelatinized starch granules, recycling flashing fragments and, optionally, damaged containers themselves represents a substantial cost savings. In addition, recycling cuts down on the fiber and filler requirements.

Accordingly, it is an object and feature of the present invention to provide apparatus and systems for removing flashing and other irregularities from molded starch-bound articles which do not result in the substantial formation of divots or other depressions which can be mechanically and/or aesthetically undesirable.

In addition, it is an object of the invention to provide apparatus and systems for removing flashing and other irregularities from molded starch-bound articles which do not leave substantial quantities of burrs or other raised portions which can be mechanically and/or aesthetically undesirable.

It is a further object and feature of the invention to provide apparatus and systems for removing flashing and other irregularities from molded starch-bound articles which do not cause substantial fracture, cracking, breakage or other types of mechanical failure of the molded articles upon removing the flashing or other irregularities.

It is also an object to provide apparatus and systems for removing flashing and other irregularities from molded starch-bound articles which also provide for the recycling of such materials back into the molding compositions used to manufacture additional articles of manufacture.

It is yet an object to provide apparatus and systems that provide for the removal of flashing from articles after they have been removed from the molds, thereby keeping the flashing from clogging the molds or otherwise interfering with the mold apparatus, and also more quickly freeing up the molds so that they may immediately be used in a subsequent molding cycle.

These and other objects and features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and objects of the invention are obtained, a more particular description of the invention briefly described above will be rendered by reference to a specific embodiment thereof which is illustrated in the appended drawings. Understanding that these drawing depict only a typical embodiment of the invention and are not therefore to be considered to be limiting of its scope, the invention will be described and explained with additional specificity and detail through the use of the accompanying drawings in which:

FIG. 1 is a perspective view of an exemplary starch-bound container that has been newly molded, namely a “claim-shell” sandwich container that includes a substantial quantity of extraneous mechanical structures attached thereto called “flashing”;

FIG. 2 is a box diagram of the various components within a preferred flashing removal system equipped with means for recycling removed flashing and culled articles;

FIG. 3 is a perspective view of a preferred cutting system for slicing and removing flashing structures, globules and other extraneous materials from newly molded articles;

FIG. 3A is a perspective view taken along section line 3A-3A depicting the generally smooth-edged blade within the cutting system of FIG. 3;

FIG. 3B is a perspective view depicting a serrated blade, which is an alternative blade configuration for use within the cutting system of FIG. 3;

FIG. 4 is a side view of the cutting system of FIG. 3, more particularly depicting how the severed flashing globules, stems or other extraneous features are severed by a cutting blade and carried away by means of a vacuum; and

FIG. 5 is a side view of a preferred abrading system for removing any remaining nubs or other irregularities in order to yield a substantially smooth outer article surface or edge.

### DETAILED DESCRIPTION OF THE PREFERRED EMBODIMENTS

The present invention relates to novel methods and systems for finishing molded starch-bound articles, particularly the removal of flashing from newly molded containers or other articles. Starch-bound articles are typically molded from aqueous starch-based compositions using heated molds. The aqueous starch-based compositions are heated to above the boiling point of water in order to cause such compositions to expand and fill the mold cavity. Water in the form of water vapor or steam is allowed to escape from the mold by means of vent holes or other vent passages or gaps. The tremendous pressure build up within the mold also causes a quantity of the molding composition to also exit through the vent holes or vent gap, thereby yielding irregularities attached to the molded articles known as “flashing”. The present invention provides methods and systems for removing such flashing.

Examples of compositions, methods and systems used to mold starch-bound articles of manufacture from aqueous starch-based compositions are set forth more fully in U.S. Pat. Nos. 5,660,900, 5,662,731, 5,679,145, 5,683,772, 5,705,203, 5,709,827, 5,776,388, 5,783,126, 5,843,544, 5,868,824, and copending U.S. application Ser. No. 09/539,549, filed Mar. 31, 2000. The foregoing patents and application are presently assigned to E. Khashoggi Industries, LLC, located in Santa Barbara, Calif. For purposes of disclosure, the foregoing patents and application are incorporated herein by specific reference.

The terms “starch-bound articles”, “molded starch-bound articles”, “newly demolded starch-bound articles” and variations thereof shall broadly refer to any container or molded article that is capable of being manufactured using aqueous starch-based compositions. Examples of articles that can be manufactured from aqueous starch-based compositions are set forth in the afore-mentioned patents, and include “clam-shell” sandwich containers, bowls, cups, plates, boxes, lids and the like.

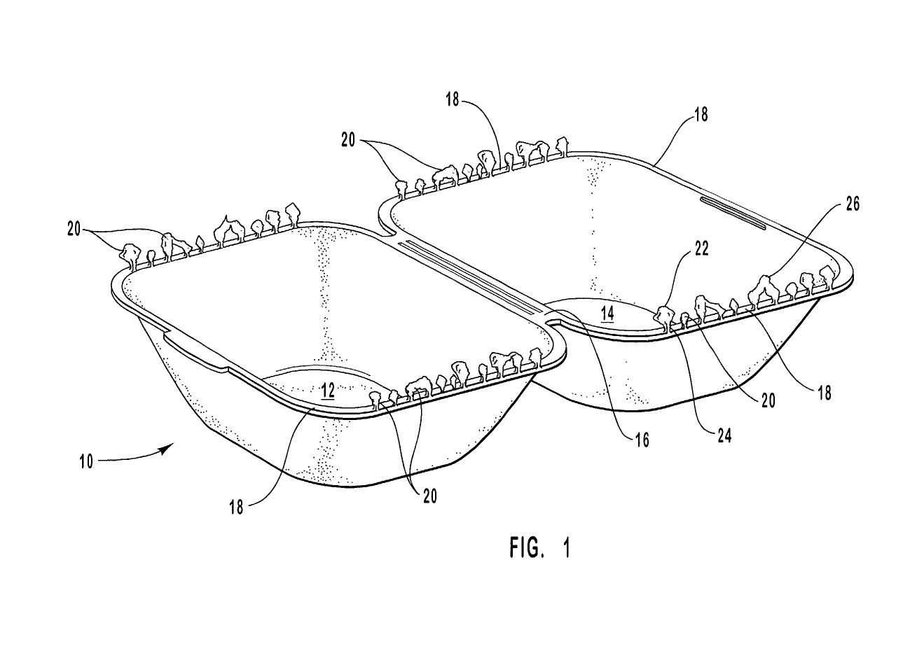

FIG. 1 depicts an exemplary newly demolded starch-bound article having attached irregularities in the form of “flashing” that may be removed according to the apparatus and systems of the present invention, namely a “clam-shell” container. In particular, Figure depicts a container 10 which includes a top half 12 connected to a bottom half 14 by means of a hinge structure 16. Protruding outwardly from an upper edge or rim 18 are a plurality of flashing structures 20 comprising excess mold material. In most cases, the flashing structures 20 will include an enlarged globule portion 22 that is attached to the rim 18 by means of a flashing stem 24. In many cases, the globules 22 may merge together so as to form a complex globule structure 26 attached by two or more stems 24. Whereas FIG. 1 illustrates an exemplary claim-shell container, it will readily be appreciated that the inventive flashing removal systems may be used to remove flashing from a wide variety of fragile, newly demolded starch-bound articles, including, but not limited to, cups, plates, bowls, boxes, lids and the like. Accordingly, when referring to container 10, upper rim 18 and the flashing structures 20, including the enlarged globules 22, flashing stems 24, or complex globule structures 26, it will be understood that such terms may refer to any newly molded container, not only the “clam-shell” container illustrated in FIG. 1, unless specifically limited to the clam-shell.

Whereas it may be possible to remove the flashing by merely breaking off stems 24 from the container rim 18 (such as by the scraper bar described herein), in many cases the stems 24 will not all break at the desired location. For this reason the present invention provides apparatus for carefully removing substantially all of the flashing, globule and stem alike, without substantially damaging the container wall or rim 18. The present invention therefore satisfies a long-felt need for the ability to reliable remove flashing from newly demolded starch-based articles, which are in their most fragile and brittle condition, without breaking, fracturing, divoting or otherwise damaging such articles, as can happen using the scraper bar described herein.

As will be discussed more fully below, the flashing removal system preferably includes rough and fine flashing removal subsystems. The rough flashing removal subsystem preferably severs the larger globule portion from the molded article, leaving behind residual nubs or stems. Thereafter, a fine finishing subsystem is preferably used to carefully remove the remaining nubs or stems.

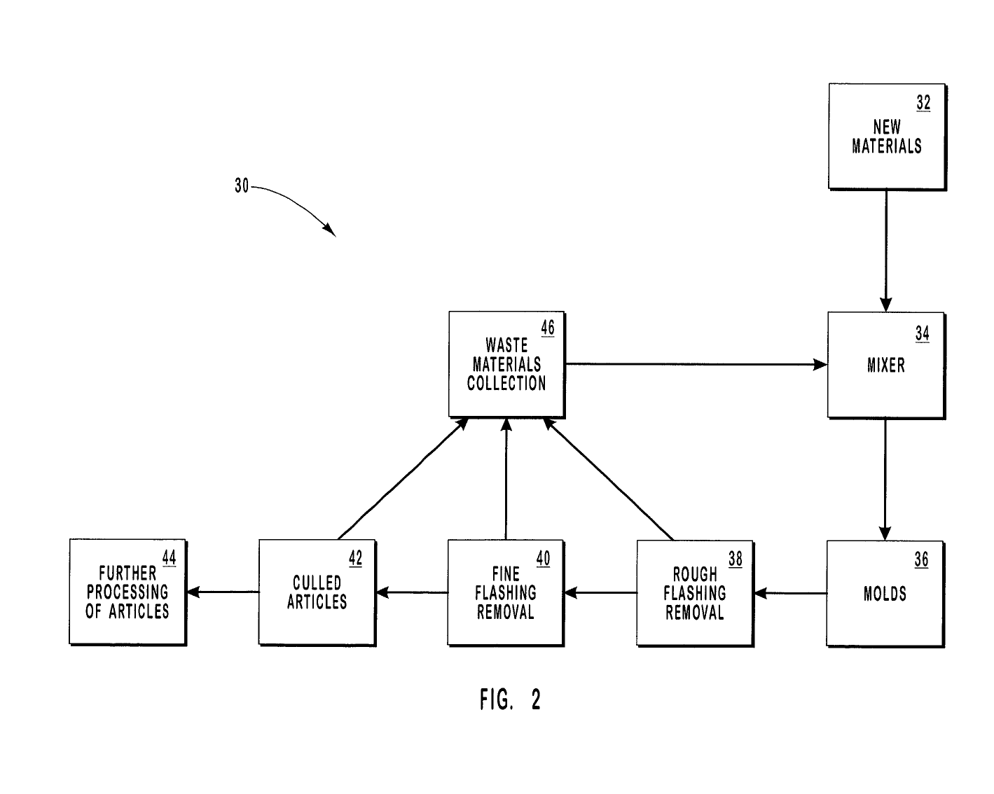

FIG. 2 is a box diagram illustrating a preferred manufacturing system 30 according to the present invention. In particular, new materials inputs 32 such as water, ungelatinized starch granules, pregelatinized starch, fibers and an inorganic filler are provided to a mixer 34. The mixer 34 yields a desired aqueous starch-based composition which is then delivered to and fed into one or more molds 36, such as paired male and female molds. The molds define a cavity (not shown) corresponding to a desired shape of a container or other article. The container or other article may comprise any desired shape, including, but not limited to, the shape of a clam-shell sandwich container, a bowl, a plate, a cup, a box, or a lid. The molds are preferably equipped with one or more vent holes and/or vent gaps (not shown) which allow water vapor to escape and be driven from the composition in order to yield a solidified molded article. Excess mold material is typically expelled from the vent holes or gaps and thereby form flashing, which is an extraneous mass of mold material attached to the molded article (FIG. 1).

In a preferred embodiment, the molded articles are conveyed to a first rough flashing removal subsystem or station responsible for removing the majority of flashing, to be discussed hereinbelow. Thereafter, the articles are sent to a second fine flashing removal subsystem or station where substantially all of the remaining nubs or flashing is removed. After that, the articles are examined by quality control means in order to remove broken or damaged articles as culls prior to further processing. Flashing fragments and dust are removed and sent to a waste materials collection subsystem. Optionally, culled articles can also be sent to the waste materials collection subsystem.

The waste materials derived from the removed flashing and/or culled articles can be recycled back into the mixture as a source of gelatinized starch and other feed materials, such as fibers, inorganic fillers, mold release agent and other desirable admixtures. In order to maintain the proper ratio of the various materials within the mixture, one of ordinary skill in the art will be able to adjust the relative feed rates of the waste materials and new materials, respectively, in order to yield an appropriate and desired aqueous starch-based mixture.

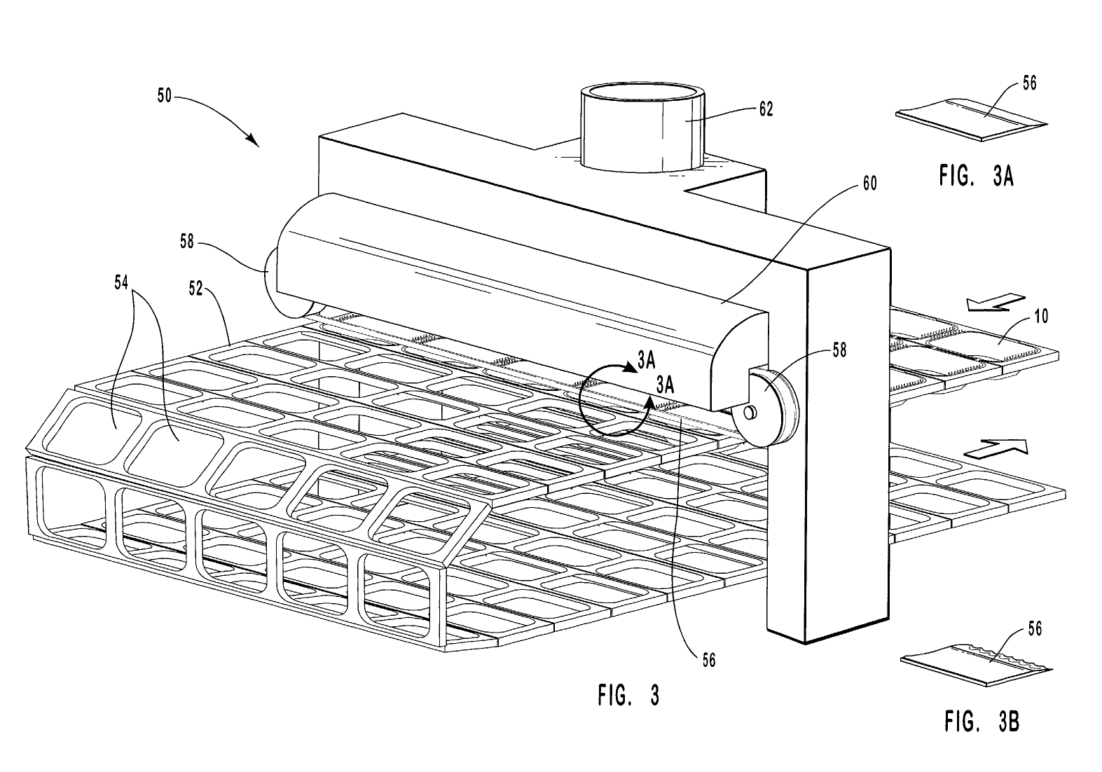

Reference is now made to FIG. 3, which is an elevational perspective view of a preferred cutting system 50. The cutting system 50 is designed to remove the majority of flashing from newly demolded articles, particularly enlarged globules and at least a portion of the flashing stems (e.g., globules 22 and stems 24 of container 10 depicted in FIG. 1). A conveyor 52 having individual recesses or nests 54 is preferably used to transport molded containers (not shown) from the molds 36 (FIG. 2) to the cutting system 50. The conveyor includes a two-dimensional planar array of individual nests 54 corresponding to a planar array of molds (not shown) used to mold the containers. The purpose of the nests 54 is to retain a plurality of molded containers in a desired orientation (e.g., a two-dimensional planar array) during removal of the flashing. In this way, substantial mechanical forces can be applied to the molded containers during flashing removal without dislodging the articles from off the conveyor and without causing damage to the articles.

While the conveyor embodiment depicted in FIG. 3 is shown as having five rectangular nests 54 across the width-wise direction, this is purely illustrative, and the conveyor may include any number of nests 54 across the width-wise direction, from 1 to 8, to 16 or more as desired. The nests will preferably be shaped to conform to the particular molded containers being treated (i.e., round nests are preferably used to accommodate round articles, such as cups, bowls or plates). The number of nests 54 in the length-wise direction is essentially infinite to extent the conveyor 52 operates in a continuous loop, as depicted in FIG. 3.

It will be appreciated that adhesion or retention of the molded containers by the conveyor or other conveying means may be carried out by any container retention means known in the art. Such article retention means includes, but is not limited to, suction, electrostatic attraction, mechanical restraint, and the like.

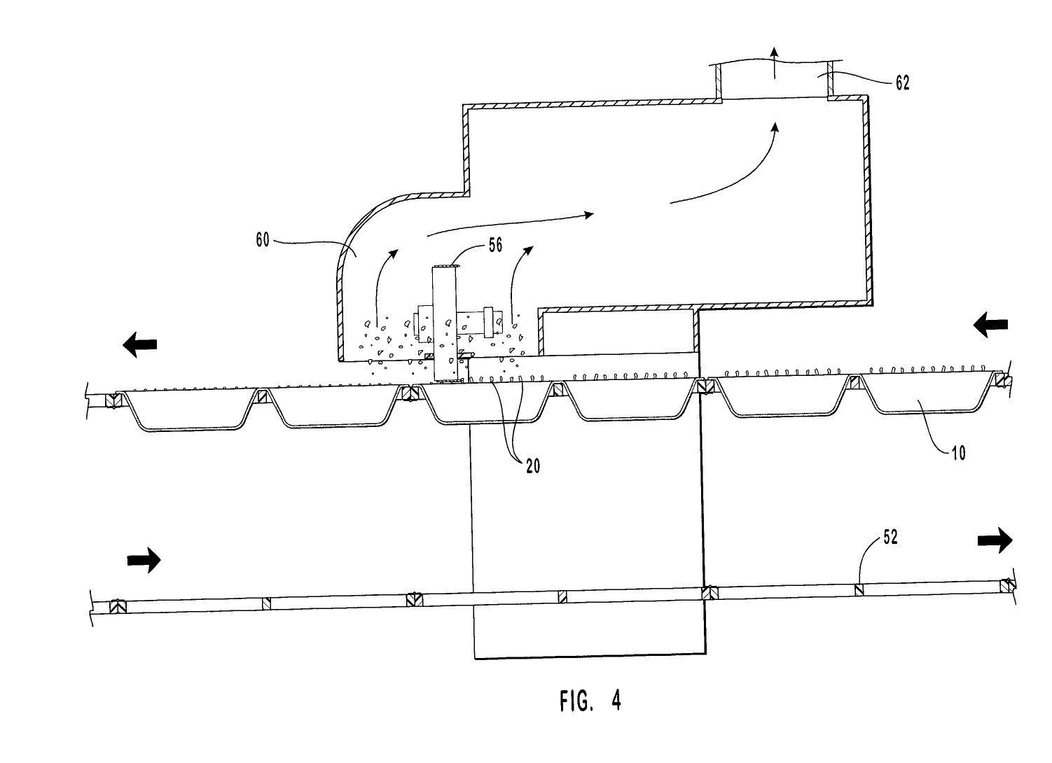

The embodiment depicted in FIG. 3 further includes a rotating band blade 56 that rotates about two or more wheels 58. The band blade 56 is preferably oriented so as to shave or slice off the flashing globules 22 and at least a portion of the stems 24 without damaging the upper rim 18 of the molded article 10. A vacuum hood 60 draws the flashing fragments removed from molded containers 10 (FIG. 4) by means of the rotating band blade 56 and sends them through a vacuum port 62. The band blade 56 preferably has a length that is at least equal to the width of the conveyor 52 so that it can cut the flashing 20 in a single pass from a plurality of molded articles nested across the width of the conveyor 52 within the plurality of nests 54. In this way, economies of scale are attained as multiple articles are simultaneously trimmed. This, in turn, speeds up the ability to provide trimmed molded articles for further downstream processing.

The depiction of a relatively smooth, toothless cutting blade on the forward edge of band blade 56 is illustrative rather than limiting. The cutting blade may have any desired and appropriate cutting edge, such as a serrated edge. It should be appreciated that the band blade 56 may be configured to have any number of cutting edges, such as a smooth but sharp edge, as illustrated in FIG. 3A, or a serrated cutting edge, as illustrated in FIG. 3B. The sharpness and/or depth of the serrations, if any, may be selected in order to provide optimal cutting of the particular mold material being employed. The optimal cutting surface will depend on the materials and properties of the molded container. One of ordinary skill in the art will be able to select an appropriate cutting edge for a particular application. In most cases, a smooth but sharp cutting edge is preferred so as to effect cutting with a minimum of snagging or gouging.

FIG. 4 more particularly depicts how the flashing or other irregularities are severed from the container edge or rim by means of the rotating band blade 56, as well as how the severed fragments or particles are drawn away from the molded articles 10 by means of the vacuum hood 60 and out through the vacuum port 62. As shown by the arrows in the embodiment depicted in FIG. 4, the demolded containers 10 are conveyed by the conveyor 52 toward the band blade 56 along a longitudinal direction in order to bring the flashing structures 20 into the contact with the band blade 56. The band blade 56 remains stationary other than turning about the wheels 58 to create a transverse slicing action relative to the longitudinal direction of the conveyor 52, as well as the upper edges 18 of the newly demolded articles 10. Thus, the speed of the conveyor 52 determines how fast the flashing 20 is removed from the array of molded articles. One will appreciate, however, that one could readily design a cutting system 50 in which the band blade 56 is moved relative to the containers 10, or in which both the containers 10 and the band blade 56 move relative to each other.

The band blade 56 is preferably adjustable so as to alter the angle and height of the cutting edge in order to fine tune the removal of flashing from a particular type of molded container or article. Because it will generally not be desirable for the band blade to actually make contact with the upper edge or rim 18 of a molded container 10, so as to not dislodge the container from the conveying system, the band blade 56 will preferably be adjusted so as to leave a tiny flashing stem or nub attached to the container, which is removed by a fine flashing removal substation, to be discussed hereafter. In general, it is preferable to remove as much of the flashing stem as possible without damaging the container. In this way further flashing removal is minimized or eliminated. Thus, it should be appreciated that it is certainly within the scope of the invention to provide a flashing removal system consisting solely of a cutting blade. Such a cutting blade may be oriented to slice off all or substantially all of the flashing as desired with no additional finishing or final removal step.

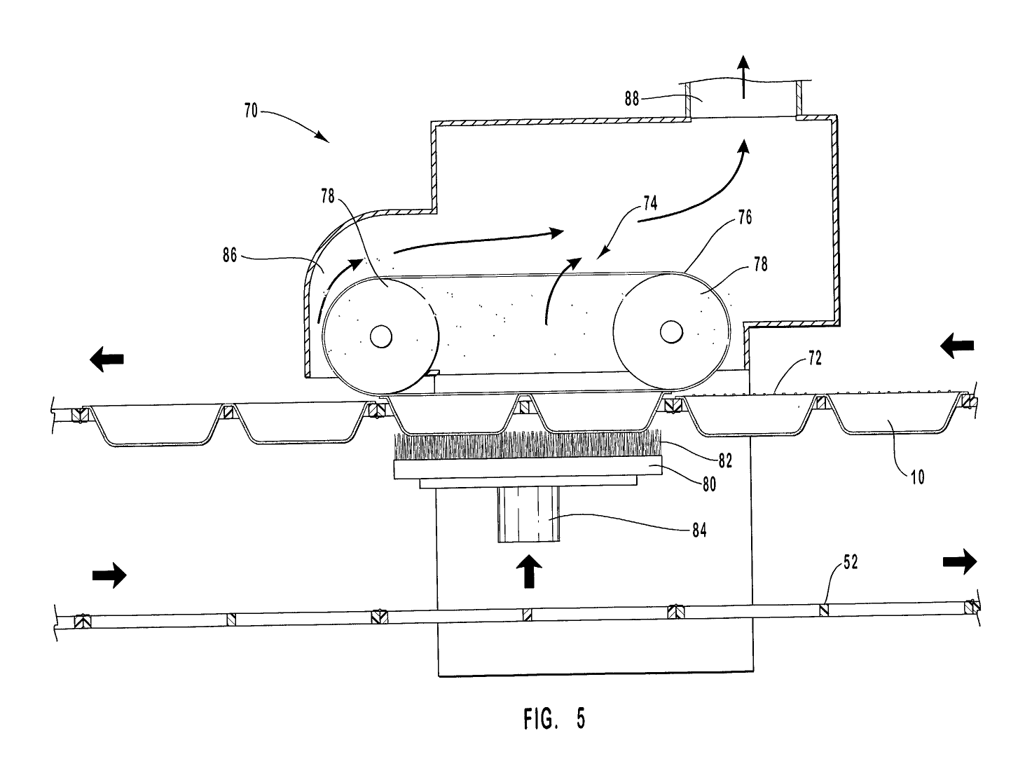

Reference is now made to FIG. 5, which depicts an abrading system 70 for removing the remaining flashing nubs or stems 72 remaining on the molded containers 10 after the cutting or slicing process described above. In a preferred embodiment, the fine flashing removal subsystem 70 includes a belt sander 74, which includes a sanding belt 76 that rotates about two or more wheels or cylinders 78. As with the band blade 56 discussed above, the sanding belt 76 will preferably have a length that approximately corresponds to the width of the conveyor 52 so that a plurality of containers can be abraded at the same time, thus achieving economies of scale as discussed above. Alternatively, the sanding belt 76 may itself have a width that substantially corresponds to the width of the conveyor 52 and move in the same direction as, or opposite to, the longitudinal direction of the conveyor 52.

As indicated by the arrows depicted in FIG. 5, the belt sander 74 remains stationary other than turning about the cylinders 78 to create a sanding or abrading action relative to the upper edges 18 of the molded articles 10. Thus, the speed of the conveyor 52 determines how fast the nubs or stems 72 are removed from the array of molded articles 10. One will appreciate, however, that one could readily design an abrading system 70 in which the sanding belt 76 is moved relative to the containers 10, or in which both the containers 10 and the sanding belt 76 move relative to each other.

The embodiment depicted in FIG. 5 further includes a plenum 80 to which a plurality of soft, flexible bristles 82 are attached. The plenum 80 is moveable so as to be capable of being selectively raised and lowered as desired in order to intermittently urge the molded containers 10 or other articles against the sanding surface of the sanding belt 76. The plenum 80 may be caused to move up and down by means of a pneumatically or hydraulically driven shaft 84 or any other appropriate means known in the art. The molded containers 10 are preferably able to rise slightly out of the nests 54 in order to provide biasing contact with the sanding surface of the sanding belt 76. Upon lowering the plenum 80, the containers 10 or other articles are able to drop back down into nests 54 for transport and further processing.

The purpose of the flexible bristles 82 is to provide a gentle biasing effect of the containers 10 against the sanding belt 76 in order to provide sufficient, but not too much, force in order to create the desired amount of friction and mechanical interaction between the containers or other articles and the sanding belt 76. Without the soft flexible bristles 82 it would be necessary to provide a much more exact movement of plenum 80 in order to provide adequate sanding friction but not so much that damage to the container would result. Instead of soft flexible bristles 82, any gentle biasing means known in the art may be employed, such as springs, air, vibrations, and the like.

The abrading system 70 further includes means for withdrawing or evacuating the abraded flashing dust therefrom and away from the conveyor apparatus. A vacuum hood 86 in communication with a vacuum conduit 88 is depicted in FIG. 5. By providing a continuous vacuum or suction in the vicinity of the belt sander 74 the vacuum hood 86 is able to effectively scavenge and remove substantially all of flashing dust produced by the sanding action. As discussed above, the sanded flashing dust may be recycled into new containers as desired.

Where the fine flashing removal station is the only flashing removal station, as an alternative embodiment, the belt sander or other abrasion device may be set at an angled pitch (not shown) to facilitate incremental removal of the flashing. For example, as the molded container contacts belt sander, the first portion of belt sander to contact the flashing may be set at a distance that is higher than the last portion of the belt sander to contact the container. Thus, the flashing would be incrementally abraded or sanded off in stages using this approach. In other words, the height-to-width aspect ratio of the flashing would be progressively diminished between the leading edge of belt sander and the trailing edge thereof, as it encounters the molded container, until the flashing is substantially removed down to the rim. Accordingly, a belt sander that is configured to remove the flashing without the assistance of the first flashing removal station may be understood to be an example of a combination of both the first means for removing a major portion of the flashing and the second means for removing a minor portion of the flashing not removed by the first means.

In an alternative embodiment of the present invention, a cutting blade and a belt sander may be situated under a single suction hood (not shown).

In summary, the present invention provides apparatus and systems for removing flashing and other irregularities from molded starch-bound articles which do not result in the substantial formation of divots or other depressions which can be mechanically and/or aesthetically undesirable.

The present invention also provides apparatus and systems for removing flashing and other irregularities from molded starch-bound articles which do not leave substantial quantities of burrs or other raised portions which can be mechanically and/or aesthetically undesirable.

The invention further provides apparatus and systems for removing flashing and other irregularities from molded starch-bound articles which do not cause substantial fracture, cracking, breakage or other types of mechanical failure of the molded articles upon removing the flashing or other irregularities.

The invention yet provides apparatus and systems for removing flashing and other irregularities from molded starch-bound articles which also provide for the recycling of such materials back into the molding compositions used to manufacture additional articles of manufacture.

The invention additionally provides apparatus and systems that provide for the removal of flashing from articles after they have been removed from the molds, thereby keeping the flashing from clogging the molds or otherwise interfering with the mold apparatus, and also more quickly freeing up the molds so that they may immediately be used in a subsequent molding cycle.

The present invention may be embodied in other specific forms without departing from its spirit or essential characteristics. The described embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. A system for removing extraneous mold material from newly demolded articles of manufacture, comprising:
conveyor means for simultaneously conveying a plurality of newly demolded articles of manufacture having extraneous mold material attached thereto from a mold system to a flashing removal system; and
a flashing removal system including flashing removal means for simultaneously removing a substantial portion of the extraneous mold material from at least two of the newly demolded articles of manufacture, wherein the flashing removal means includes at least one of means for cutting or means for abrading.

2. A system for removing extraneous mold material as defined in claim 1, wherein the conveyor means includes a conveyor that travels around in a loop and that includes an array of nests, each of which is configured to receive therein a newly demolded article of manufacture from the mold system and then retain the article during flash removal.

3. A system for removing extraneous mold material as defined in claim 2, wherein at least a portion of the array of nests is substantially planar while the portion is adjacent to the flashing removal system.

4. A system for removing extraneous mold material as defined in claim 1, further comprising means for recycling at least at portion of the extraneous mold material in manufacturing additional articles of manufacture.

5. A system for removing extraneous mold material as defined in claim 1, wherein the flashing removal means includes:
cutting means for simultaneously cutting a substantial portion of the extraneous mold material from the at least two newly demolded articles of manufacture; and
abrading means for simultaneously abrading at least a portion of any extraneous mold material that remains attached to the at least two newly demolded articles of manufacture following operation of the cutting means.

6. A system for removing extraneous mold material as defined in claim 5, wherein the conveyor means conveys the two or more newly demolded articles of manufacture along a longitudinal direction, wherein the cutting means includes a blade that moves in a direction transverse to the longitudinal direction of the conveyor in order for the blade to perform a slicing action relative to the extraneous mold material.

7. A system for removing extraneous mold material as defined in claim 6, wherein the blade oscillates from side to side or turns in a continuous loop.

8. A system for removing extraneous mold material as defined in claim 6, wherein the blade has a substantially straight or serrated cutting edge.

9. A system for removing extraneous mold material as defined in claim 5, wherein the abrading means comprises a belt sander configured so as to abrade extraneous mold material from the at least two demolded articles of manufacture.

10. A system for removing extraneous mold material as defined in claim 1, wherein the newly demolded articles of manufacture include starch-bound containers selected from the group consisting of clam shell sandwich containers, cups, plates, bowls, and lids.

11. A system for removing extraneous mold material as defined in claim 10, wherein the starch-bound containers have a starch-bound cellular matrix that is fragile and brittle during flash removal.

12. A system for removing extraneous mold material from newly demolded containers, comprising:
a conveyor that simultaneously conveys a plurality of newly demolded containers having extraneous mold material attached to an upper rim of each container from a mold system to a flashing removal system, the conveyor traveling around in a loop and including an array of nests, each of which is configured to receive therein a newly demolded container from the mold system and then retain the container during flash removal; and
a flashing removal system configured so as to simultaneously remove a substantial portion of extraneous mold material from the upper rims of at least two of the newly demolded containers, wherein the flashing removal system includes at least one of (i) a blade configured to simultaneously remove at least a portion of the extraneous mold material from the at least two newly demolded containers or (ii) a sander configured to simultaneously remove at least a portion of the extraneous mold material from the at least two newly demolded containers.

13. A system for removing extraneous mold material as defined in claim 12, wherein the extraneous mold material is removed from the flashing removal system by means of a vacuum.

14. A system for removing extraneous mold material as defined in claim 12, wherein the conveyor moves in a longitudinal direction and wherein the blade comprises a band blade that travels around in a loop in a direction transverse to the longitudinal direction of the conveyor in order for the blade to perform a slicing action relative to the extraneous mold material.

15. A system for removing extraneous mold material as defined in claim 14, wherein the flashing removal system includes the band blade and a sanding belt, wherein the band blade removes at least a portion of the extraneous mold material from the newly demolded containers and wherein the sanding belt further removes extraneous material that may remain attached to the molded article following the cutting step.

16. A system for removing extraneous mold material as defined in claim 12, wherein at least a portion of the array of nests is substantially planar while the portion is adjacent to the flashing removal system, wherein the at least two newly demolded containers are retained within adjacent nests and wherein the upper rims of the at least two newly demolded containers are substantially coplanar during removal of the extraneous mold material by the flashing removal system.

17. A system for removing extraneous mold material as defined in claim 12, wherein the newly demolded containers include starch-bound containers which have a starch-bound cellular matrix and which are selected from the group consisting of clam shell sandwich containers, cups, plates, bowls, and lids.

18. A system for removing extraneous mold material from newly demolded starch-bound containers, comprising:
a conveyor that simultaneously conveys a plurality of newly demolded starch-bound containers that are fragile and brittle and that have extraneous mold material attached to an upper rim of each container from a mold system to a flashing removal system, the conveyor traveling around in a loop and including an array of nests, each of which is configured to receive therein a newly demolded container from the mold system and then retain the container during flash removal; and
a flashing removal system configured so as to simultaneously remove a substantial portion of extraneous mold material from the upper rims of at least two of the newly demolded starch-bound containers without causing significant damage to the newly demolded starch-bound containers, wherein the flashing removal system includes at least one of (i) a blade configured to simultaneously remove at least a portion of the extraneous mold material from the at least two newly demolded starch-bound containers or (ii) a sander configured to simultaneously remove at least a portion of the extraneous mold material from the at least two newly demolded containers.

19. A system for removing extraneous mold material as defined in claim 18, wherein at least a portion of the array of nests is substantially planar while the portion is adjacent to the flashing removal system, wherein the at least two newly demolded starch-bound containers are retained within adjacent nests in a manner so as to protect the containers from significant damage and wherein the upper rims of the at least two newly demolded containers are substantially coplanar during removal of the extraneous mold material by the flashing removal system.

20. A system for removing extraneous mold material as defined in claim 18, wherein the newly demolded starch-bound containers have a starch-bound cellular matrix and are selected from the group consisting of clam shell sandwich containers, cups, plates, bowls, and lids.
